(19) United States
(12) Patent Application Publication
(10) Pub. No.: US 2025/0057231 A1
(43) Pub. Date: Feb. 20, 2025

(54) AEROSOL GENERATING DEVICE AND HEATER THEREFOR

(71) Applicant: SHENZHEN FIRST UNION TECHNOLOGY CO., LTD., Shenzhen, Guangdong (CN)

(72) Inventors: Pengyu ZHUANG, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/723,305

(22) PCT Filed: Dec. 16, 2022
(86) PCT No.: PCT/CN2022/139696

§ 371 Date: Jun. 21, 2024

(30) Foreign Application Priority Data
Dec. 21, 2021 (CN) 202111569089.X

(51) Int. Cl. A24F 40/46; A24F 40/20; H05B 3/48

(52) U.S. Cl. CPC A24F 40/46; A24F 40/20; H05B 3/48; H05B 2203/016

(57) ABSTRACT

An aerosol generating device and a heater are provided. The device includes a chamber for accommodating an aerosol generating product. The heater is inserted into the aerosol generating product to heat the aerosol generating product. The heater has a free front end and a tail end opposite the free front end. The heater includes a base body, a resistance heating coil and a protective coating. The base body extends between the free front end and the tail end in the length direction of the heater. The resistance heating coil surrounds the base body. The protective coating surrounds at least a part of the resistance heating coil and holds the resistance heating coil outside the base body.

### CROSS-REFERENCE TO RELATED APPLICATION

This application claims priority to Chinese Patent Application No. 202111569089.X, filed with the China National Intellectual Property Administration on Dec. 21, 2021 and entitled “AEROSOL GENERATING DEVICE AND HEATER THEREFOR”, which is incorporated herein by reference in its entirety.

### TECHNICAL FIELD

Embodiments of this application relate to the field of aerosol generating technologies, and in particular, to an aerosol generating device and a heater therefor.

### BACKGROUND

During use of a smoking product (such as a cigarette or a cigar), tobacco is burned to generate tobacco smoke. Attempts are made to manufacture a product that releases a compound without burning, to replace the product that burns the tobacco.

An example of the product is a heating device that releases a compound through heating rather than burning a material. For example, the material may be tobacco or another non-tobacco product. The non-tobacco product may or may not include nicotine. In a known technology, it is proposed in Patent NO. CN202010054217.6 that a tobacco product is heated by using a heater in which a spiral heating wire is encapsulated in an outer sleeve, to generate an aerosol.

### SUMMARY

An embodiment of this application provides an aerosol generating device, configured to heat an aerosol generating product to generate an aerosol. The device includes:
a chamber, configured to accommodate the aerosol generating product; and
a heater, at least partially extending into the chamber, to be inserted into and heat the aerosol generating product, where the heater includes a free front end located inside the chamber and a tail end away from the free front end, where the heater includes:
a base body, extending between the free front end and the tail end in a length direction of the heater;
a resistance heating coil, surrounding at least a part of the base body; and
a protective coating, wrapping at least a part of the resistance heating coil and maintaining the resistance heating coil outside the base body.

In a preferred implementation, the protective coating at least partially defines an outer surface of the heater.

In a preferred implementation, the protective coating includes glaze or diamond.

In a preferred implementation, a thickness of the protective coating is from 0.001 mm to 1 mm.

In a preferred implementation, the base body includes a first end close to the free front end and a second end close to the tail end.

The heater further includes:

a first wire and a second wire, configured to supply power to the resistance heating coil, where the first wire extends from the second end to the first end of the base body and is conductively connected to, at a position close to the first end, one end of the resistance heating coil, and the second wire is conductively connected to, at a position close to the second end, the other end of the resistance heating coil.

In a preferred implementation, the base body is in a shape of a tube extending in the length direction of the heater.

In a preferred implementation, the first wire at least partially extends into the base body. In a preferred implementation, a cross section of a wire material of the resistance heating coil has a first size extending in an axial direction and a second size extending in a radial direction, and the first size is greater than the second size.

In a preferred implementation, the heater further includes:

an end portion element, close to and defining the free front end of the heater, where the end portion element is arranged to abut against the first end of the base body to stop the end portion element.

In a preferred implementation, the end portion element is at least partially a conductor, and the first wire is connected to the end portion element, to be conductively connected to the resistance heating coil indirectly.

In a preferred implementation, the end portion element at least partially extends into the base body from the first end of the base body.

In a preferred implementation, the protective coating includes at least two coatings arranged in sequence from inside to outside in a radial direction of the heater.

In a preferred implementation, the protective coating includes at least a first coating and a second coating that are arranged in sequence from inside to outside, and a thermal conductivity of the second coating is greater than a thermal conductivity of the first coating.

In a preferred implementation, the protective coating is constructed to wrap the resistance heating coil and the base body simultaneously.

Another embodiment of this application further provides an aerosol generating device, configured to heat an aerosol generating product to generate an aerosol. The device includes: a heater, at least partially extending into a chamber, to be inserted into and heat the aerosol generating product, where the heater includes a free front end located inside the chamber and a tail end away from the free front end;
a base body, constructed to be in a shape of a tube extending in a length direction of the heater, and including a first end close to the free front end and a second end close to the tail end;
a resistance heating element, combined outside the base body and surrounding at least a part of the base body; and
an end portion element, close to and defining the free front end of the heater, where the end portion element at least partially extends into a tubular hollow of the base body from the first end of the base body.

Another embodiment of this application further provides a heater used in an aerosol generating device, where the heater is constructed to be in a shape of a pin, a needle, or a rod, and includes a free front end and a tail end that are away from each other in a length direction. The heater includes:
a base body, extending between the free front end and the tail end in the length direction of the heater;
a resistance heating coil, surrounding at least a part of the base body; and a protective coating, wrapping at least a part of the resistance heating coil and maintaining the resistance heating coil outside the base body.

In the foregoing aerosol generating device, the protective coating is formed outside the base body that is surrounded by the resistance heating coil, and the resistance heating coil is limited, wrapped, or fixed by the protective coating, so that the resistance heating coil is maintained outside the base body, to prevent the resistance heating coil from getting loose from or moving on the base body.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic diagram of an aerosol generating device according to an embodiment;

FIG. 2 is a schematic diagram of an embodiment of a heater in FIG. 1;

FIG. 3 is a schematic exploded view of each part in FIG. 2 before assembly;

FIG. 4 is a schematic diagram of a connection between a resistance heating coil and both a first wire and a second wire according to another embodiment;

FIG. 5 is a schematic diagram of another embodiment of a heater in FIG. 1;

FIG. 6 is a schematic diagram of an end portion element in FIG. 5;

FIG. 7 is a schematic diagram of still another embodiment of a heater in FIG. 1; and

FIG. 8 is a schematic diagram of a resistance heating coil according to still another embodiment.

### DETAILED DESCRIPTION

For ease of understanding of this application, this application is described in further detail below with reference to the accompanying drawings and specific implementations.

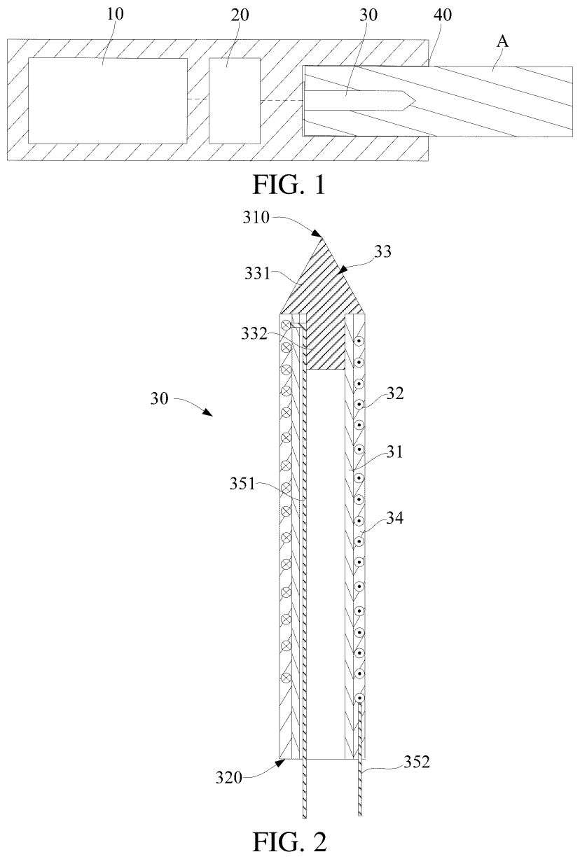

An embodiment of this application provides an aerosol generating device. For a construction of the device, refer to FIG. 1. The device includes:
a chamber, including an opening 40, where an aerosol generating product A can be removably received in the chamber through the opening 40 of the chamber during use;
a heater 30, at least partially extending into the chamber, and inserted into the aerosol generating product A for heating when the aerosol generating product A is received in the chamber, to enable the aerosol generating product A to release various volatile compounds, where the volatile compounds are generated merely through heating;
a battery cell 10, configured to supply power; and
a circuit 20, configured to conduct a current between the battery cell 10 and the heater 30.

In a preferred embodiment, the heater 30 is substantially in a shape of a pin, a needle, a stick, a rod, or a column, to help the heater 30 to be inserted into the aerosol generating product A. In addition, the heater 30 may have a length approximately from 12 mm to 20 mm, and an outer diameter size approximately from 2 mm to 4 mm.

Further, in an optional implementation, the aerosol generating product A preferably uses a material that includes tobacco and that releases volatile compounds from a substrate during heating, or may use a non-tobacco material suitable for smoke generating through electrical heating after the material is heated. The aerosol generating product A preferably uses a solid substrate. The solid substrate may include one or more of powders, granules, chip shreds, strips, or slices of one or more of vanilla leaves, tobacco leaves, homogeneous tobacco, and expanded tobacco. Alternatively, the solid substrate may include additional tobacco or non-tobacco volatile tobacco aroma compounds that are released when the substrate is heated.

During implementation, the heater 30 may usually include a resistance heating element and an auxiliary base material that assists in fixing and preparing the resistance heating clement and the like. For example, in some implementations, the resistance heating element is in a shape or form of a spiral coil. Alternatively, in some other implementations, the resistance heating clement is in a form of a conductive trajectory combined with a substrate. Alternatively, in some other implementations, the resistance heating element is in a shape of a sheet base material.

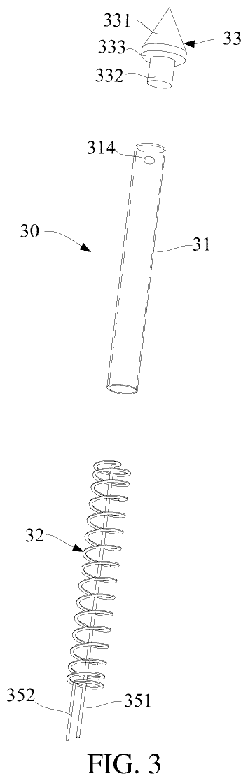

Further, FIG. 2 and FIG. 3 are schematic diagrams of an embodiment of the heater 30. The heater 30 in this embodiment includes a front end 310 and a tail end 320 that are opposite in a length direction. The front end 310 is a free end exposed inside the chamber and is constructed to be a tapered tip, to help the heater 30 to be inserted into the aerosol generating product A. The tail end 320 is an end for fixing and mounting in the aerosol generating device, and the aerosol generating device clamps the heater 30 at a position close to the tail end 320 to enable the heater 30 to be stably assembled in the device. Specifically, a construction of the heater 30 includes:
a base body 31, constructed to be in a shape of an elongated rod, a stick, or a tube extending between the front end 310 and the tail end 320 in the length direction of the heater 30. During implementation, the base body 31 is configured to support and maintain a resistance heating element 32. In a preferred implementation, the base body 31 is rigid. In addition, in this implementation, the base body 31 and the resistance heating element 32 are insulated from each other. In an optional implementation, the base body 31 includes ceramic such as zirconia ceramic or alumina ceramic, glass, surface-insulated metal, and the like.

In a preferred implementation, the resistance heating element 32 is a resistance heating coil and is prepared and obtained by winding the resistance heating coil on the base body 31 by using a winding device of a wire wound resistor. This is very convenient for modular and batch preparation of the heater 30.

In an optional implementation, the resistance heating element 32 is made of a metal material, a metal alloy, graphite, carbon, conductive ceramic, or another composite of a ceramic material and a metal material that have proper resistance. The proper metal or alloy material includes at least one of nickel, cobalt, zirconium, titanium, nickel alloy, cobalt alloy, zirconium alloy, titanium alloy, nickel-chromium alloy, nickel-iron alloy, iron-chromium alloy, iron-chromium-aluminum alloy, titanium alloy, iron-manganese-aluminum based alloy, stainless steel, or the like.

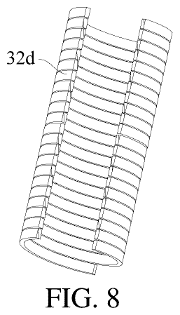

In some optional implementations, the resistance heating element 32 is a conventional resistance heating coil wound by a wire material with a circular cross section. Alternatively, in some preferred implementations, the resistance heating element 32 is a resistance heating coil wound by a wire material with a flat or rectangular cross section, such as a resistance heating clement 32d shown in FIG. 8. Specifically, an extension size of a wire material of the resistance heating element 32d is larger than an extension size in a radial direction, so that the resistance heating element 32d constructed by using a spiral coil is flattened in the axial direction, to help transfer heat. In a specific implementation, an extension size of the wire material of the resistance heating coil in the axial direction is from 0.25 mm to 2 mm, and an extension size in the radial direction is from 0.05 mm to 0.2 mm.

In some optional implementations, resistivity of the wire material of the resistance heating element 32 is from 0.5 Ωmm²/m to 1.7 Ωmm²/m, and a TGR coefficient (temperature coefficient of resistance) is from 800 ppm/° C. to 3800 ppm/° C.

In addition, a resistance value of the resistance heating element 32 is from 0.5 Ω to 3 Ω,so that a temperature of the resistance heating clement 32 can be obtained by sampling or measuring the resistance of the resistance heating element 32 during use.

In some implementations, the resistance heating element 32 constructed by the spiral coil has an inner diameter from 1.6 mm to 2.6 mm and a length from 8 mm to 45 mm.

In some implementations, the base body 31 in the shape of the stick or the tube has an outer diameter approximately from 1 mm to 3 mm and an inner diameter approximately from 0.3 mm to 2 mm, and the base body 31 has a length from approximately 10 mm to 50 mm. In a further specific implementation, the base body 31 has an outer diameter approximately from 1.6 mm to 2.0 mm and an inner diameter approximately from 0.4 mm to 1.2 mm, and the base body 31 is an alumina ceramic tube with a length from 14 mm to 25 mm.

Further refer to FIG. 2 and FIG. 3. The heater 30 further includes:
a first wire 351 and a second wire 352, connected to two ends of the resistance heating element 32, to supply power to the resistance heating element 32. During usual implementation, the first wire 351 and the second wire 352 both are prepared by using a metal or alloy material with high conductivity and low resistance. In some specific implementations, the first wire 351 and the second wire 352 each are a copper wire, a gold wire, a silver wire, a platinum-gold wire, an aluminum wire, a nickel wire, a silver-plated nickel wire, or the like.

In the implementation in FIG. 2 and FIG. 3, the first wire 351 is conductively connected to an upper end that is close to the front end 310 and that is of the resistance heating element 32 in a manner of soldering or the like. The second wire 352 is conductively connected to a lower end that is close to the tail end 320 and that is of the resistance heating element 32 in a manner of soldering or the like.

The base body 31 includes a wire hole 314 penetrating, at a position close to the front end 310, from an outer surface to a hollow inner chamber. The first wire 351 extends, in the hollow inner chamber of the base body 31, from the tail end 320 to the position close to the front end 310, and is connected to the upper end of the resistance heating element 32 after penetrating through the wire hole 314. The second wire 352 is connected to the lower end of the resistance heating clement 32 outside the base body 31.

Further refer to FIG. 2 and FIG. 3. To enable the front end 310 of the heater 30 to be the tapered tip to help the heater 30 to be inserted into the aerosol generating product A, the heater 30 further includes:
an end portion element 33, close to and defining the front end 310 of the heater 30. For a specific construction, the end portion element 33 includes a section 331 and a section 332 arranged in sequence in the length direction. During implementation, the section 331 is in a conical shape with an outer diameter gradually decreasing in a direction toward the front end 310, and the tapered tip defines the front end 310. The section 332 is in a columnar shape with a substantially constant outer diameter. In addition, the outer diameter of the section 332 is less than a maximum outer diameter of the section 331, so that a step 333 is formed between the two sections.

During assembly, the section 332 of the end portion element 33 projects from an end that is close to the front end 310 and that is of the base body 31 into the tubular hollow inner chamber of the base body 31. The end that is close to the front end 310 and that is of the base body 31 abuts against the step 333 to stop the end portion element 33. Certainly, in a preferred implementation, the section 332 and the base body 31 are in interference or tight fit.

In some specific implementations, the end portion element 33 has a total length from 2 mm to 40 mm. In the specific implementation shown in FIG. 2 and FIG. 3, the end portion clement 33 has a total length from 3 mm to 6 mm. The section 331 of the end portion element 33 has a length from 1 mm to 4 mm, preferably from 1.5 mm to 2.5 mm. The section 331 of the end portion element 33 has a maximum outer diameter from 2.0 mm to 3.0 mm. The section 332 of the end portion element 33 has a length from 2 mm to 4 mm, preferably 3 mm. The section 332 of the end portion element 33 has an outer diameter of 1.2 mm.

In this implementation, the end portion element 33 is made of a rigid material, such as ceramic or metal.

Further refer to FIG. 2. The heater 30 further includes:
a protective coating 34, formed outside the resistance heating element 32 and the base body 31 in a manner of spray, dip coating, deposition, or the like. After the protective coating 34 is formed, the resistance heating element 32 is limited, wrapped, or fixed by the protective coating 34 to be maintained outside the base body 31, to prevent the resistance heating element 32 from getting loose or moving. The protective coating 34 is a single coating such as a glaze coating or a diamond coating. The protective coating 34 has a thickness from 0.001 mm to 1 mm, preferably from 0.01 mm to 0.3 mm. The protective coating 34 is configured to wrap exposed surfaces of the resistance heating clement 32 and the base body 31, so that the heater 30 is smooth, to prevent residues, debris, or aerosol condensate that is from the aerosol generating product A from depositing on the surfaces of the base body 31 and/or the resistance heating element 32. After preparation, an outer surface of the heater 30 is jointly defined by the protective coating 34 and the section 331 of the end portion element 33. Heat from the resistance heating element 32 is directly transferred to the outer surface of the heater 30 through the protective coating 34, so that efficiency of heat transfer is higher.

Further, in some implementations, the protective coating 34 includes two or more coatings. For example, the protective coating 34 includes a first coating and a second coating that are formed in sequence from inside to outside. The first coating uses one of a glaze, diamond, or diamond-like coating, to be insulated from the resistance heating element 32. The second coating uses one of a metal, metal alloy, diamond, or diamond-like coating, to more rapidly transfer the heat from the resistance heating element 32 to the surface of the heater 30 to heat the aerosol generating product A. Based on the above, the first coating provides wrapping and insulation for the resistance heating element 32, and a thermal conductivity of the second coating is greater than a thermal conductivity of the first coating, to help both rapid heat transfer and heat spreading.

Further, in a more preferred implementation, the protective coating 34 may further include an anti-adhesive coating formed outside the second coating that is made of a metal or metal alloy material, to prevent organics or aerosol condensate that is from the aerosol from depositing on the surface of the heater 30. During implementation, the anti-adhesive coating is an aqueous nanoceramic coating with a smoother surface, or a free-energy organic coating with a low surface, to improve anti-adhesive performance of the surface of the heater 30.

In addition, the foregoing protective coating 34 is obtained by sintering and curing a raw material of the glaze, diamond, or diamond-like coating after the raw material is formed on the resistance heating element 32.

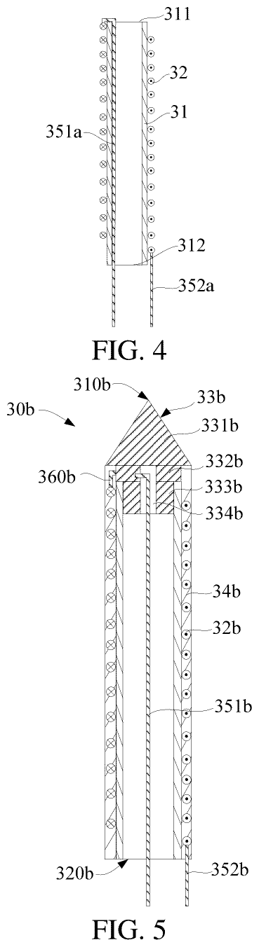

In another optional implementation, as shown in FIG. 4, after penetrating from an end portion that is close to the tail end 320 and that is of the base body 31 to the other end, a first wire 351a crosses a tube wall of the base body 31 in the radial direction to be connected to an end portion of the resistance heating element 32.

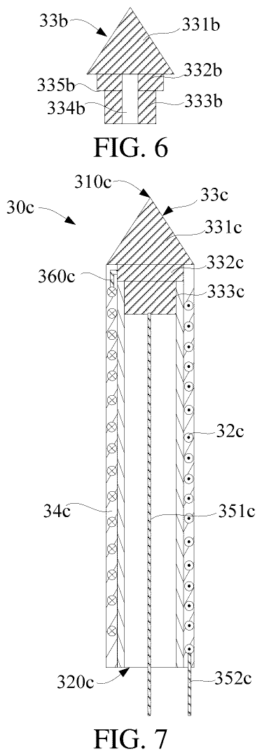

Further, FIG. 5 and FIG. 6 are schematic diagrams of another embodiment of a heater 30b. The heater 30b in this embodiment includes:
a base body 31b, substantially in a shape of a tube extending between a front end 310b and a tail end 320b that are of the heater 30b;
a resistance heating element 32b, such as a resistance heating coil, surrounding or winding the base body 31b; and
an end portion element 33b, close to and defining the front end 310b of the heater 30b, where the end portion element 33b includes a section 331b, a section 332b, and a section 333b arranged in sequence.

Further refer to FIG. 6. The section 331b is in a conical shape with an outer diameter gradually decreasing in a direction toward the front end 310b, and a tapered tip of the section 331b defines the front end 310b of the heater 30b. The section 332b and the section 333b both are in a columnar shape with a constant outer diameter. An outer diameter of the section 332b is less than a maximum outer diameter of the section 331b, and an outer diameter of the section 333b is less than the outer diameter of the section 332b. Therefore, a step 335b is defined between the section 333b and the section 332b. During assembly, the section 333b projects from an end portion that is close to the front end 310b and that is of the base body 31b into the base body 31b, to be tightly fixed to the base body 31b. The base body 31b abuts against the step 335b to support and stop the end portion element 33b.

The end portion element 33b includes a hole 334b penetrating the section 332b and the section 333b. In the figure, the hole 334b terminates at the section 331b.

In this implementation, at least the section 332b of the end portion element 33b is a conductor made of a metal or alloy material. An upper end of the resistance heating element 32b is conductively connected to an outer surface of the section 332b by using silver paste, solder, a solder wire 360b, or the like.

A first wire 351b extends from the tail end 320b into the hole 334b of the end portion element 33b and is conductively connected to an inner surface of the section 332b in a manner of soldering or the like, to be conductively connected to the upper end of the resistance heating element 32b indirectly. The first wire 351b extends from a tubular hollow inner chamber of the base body 31b into the hole 334b of the end portion element 33b.

A second wire 352b is directly connected to a lower end of the resistance heating element 32b in a manner of soldering, crimping, or the like.

In addition, heater 30 further includes a protective coating 34b, formed outside the resistance heating element 32b and the base body 31b in a manner of spray, dip coating, deposition, or the like.

In this implementation, the end portion element 33b is obtained by sequentially soldering the section 331b, the section 332b, and the section 333b that are prepared by using different materials. For example, the section 331b is made of a ceramic material, the section 332b is made of a conductive material, and the section 333b is made of a ceramic material.

Alternatively, in another optional implementation, as shown in FIG. 7, a section 332c and a section 333c that are of an end portion element 33c of a heater 30c are both prepared by using a conductive material. In this way, an upper end of a resistance heating element 32c is connected to an outer surface of the section 332c of the end portion element 33c by using silver paste, solder, a solder wire 360c, or the like, and a first wire 351c is soldered to an exposed surface of the section 333c, so that the first wire 351c is conductively connected to the upper end of the resistance heating element 32c indirectly.

Therefore, in this implementation, an entirety of the end portion element 33c is prepared by using a conductive material such as a single metal or alloy, for example, powder metallurgy.

It should be noted that, the specification of this application and the accompanying drawings thereof illustrate preferred embodiments of this application, but this application is not limited to the embodiments described in the specification. Further, a person of ordinary skill in the art may make improvements or variations based on the foregoing descriptions, and such improvements and variations shall all fall within the protection scope of the appended claims of this application.

1. An aerosol generating device, configured to heat an aerosol generating product to generate an aerosol, wherein the device comprises:
a chamber, configured to accommodate the aerosol generating product; and
a heater, at least partially extending into the chamber, to be inserted into and heat the aerosol generating product, wherein the heater comprises a free front end located inside the chamber and a tail end away from the free front end,
wherein the heater comprises:
a base body, extending between the free front end and the tail end in a length direction of the heater;
a resistance heating coil, surrounding at least a part of the base body; and
a protective coating, wrapping at least a part of the resistance heating coil and maintaining the resistance heating coil outside the base body.

2. The aerosol generating device according to claim 1, wherein the protective coating at least partially defines an outer surface of the heater.

3. The aerosol generating device according to claim 1, wherein the protective coating comprises glaze or diamond.

4. The aerosol generating device according to claim 1, wherein a thickness of the protective coating is from 0.001 mm to 1 mm.

5. The aerosol generating device according to claim 1,
wherein the base body comprises a first end close to the free front end and a second end close to the tail end; and
wherein the heater further comprises:
a first wire and a second wire, configured to supply power to the resistance heating coil, wherein the first wire extends from the second end to the first end of the base body and is conductively connected to, at a position close to the first end, one end of the resistance heating coil, and the second wire is conductively connected to, at a position close to the second end, the other end of the resistance heating coil.

6. The aerosol generating device according to claim 5, wherein the base body is in a shape of a tube extending in the length direction of the heater.

7. The aerosol generating device according to claim 6, wherein the first wire at least partially extends into the base body.

8. The aerosol generating device according to claim 1, wherein a cross section of a wire material of the resistance heating coil has a first size extending in an axial direction and a second size extending in a radial direction, and the first size is greater than the second size.

9. The aerosol generating device according to claim 5, wherein the heater further comprises:
an end portion element, close to and defining the free front end of the heater, wherein the end portion element is arranged to abut against the first end of the base body to stop the end portion element.

10. The aerosol generating device according to claim 9, wherein the end portion element is at least partially a conductor, and the first wire is connected to the end portion element, to be conductively connected to the resistance heating coil indirectly.

11. The aerosol generating device according to claim 9, wherein the end portion element at least partially extends into the base body from the first end of the base body.

12. The aerosol generating device according to claim 9, wherein:
the end portion element comprises a first section and a second section that are arranged in sequence;
the first section is exposed outside the base body and defines the free front end; and
the second section extends into the base body from the first end of the base body.

13. The aerosol generating device according to claim 1, wherein the protective coating is constructed to wrap the resistance heating coil and the base body simultaneously.

14. The aerosol generating device according to claim 1, wherein the protective coating comprises at least two coatings arranged in sequence from inside to outside in a radial direction of the heater.

15. The aerosol generating device according to claim 1, wherein the protective coating comprises at least a first coating and a second coating that are arranged in sequence from inside to outside, and a thermal conductivity of the second coating is greater than a thermal conductivity of the first coating.

16. An aerosol generating device, configured to heat an aerosol generating product to generate an aerosol, wherein the device comprises:
a heater, at least partially extending into a chamber, to be inserted into and heat the aerosol generating product, wherein the heater comprises a free front end located inside the chamber and a tail end away from the free front end;
a base body, constructed to be in a shape of a tube extending in a length direction of the heater, and comprising a first end close to the free front end and a second end close to the tail end;
a resistance heating element, combined outside the base body and surrounding at least a part of the base body; and
an end portion element, close to and defining the free front end of the heater, wherein the end portion element at least partially extends into a tubular hollow of the base body from the first end of the base body.

17. A heater used in an aerosol generating device, wherein the heater is constructed to be in a shape of a pin, a needle, or a rod, and comprises a free front end and a tail end arranged away from each other in a length direction, and the heater comprises:
a base body, extending between the free front end and the tail end in the length direction of the heater;
a resistance heating coil, surrounding at least a part of the base body; and
a protective coating, wrapping at least a part of the resistance heating coil and maintaining the resistance heating coil outside the base body.
